(19) United States
(12) Patent Application Publication
(10) Pub. No.: US 2024/0405868 A1
(43) Pub. Date: Dec. 5, 2024

(54) OPTICAL TRANSMISSION DEVICE, OPTICAL TRANSMISSION SYSTEM, AND OPTICAL TRANSMISSION METHOD

(71) Applicant: Fujitsu Limited, Kawasaki-shi (JP)

(72) Inventors: GOJI NAKAGAWA, Sagamihara (JP); Kentaro KAWANISHI, Kawasaki (JP); Tomohiro YAMAUCHI, Kawasaki (JP)

(73) Assignee: Fujitsu Limited, Kawasaki-shi (JP)

(21) Appl. No.: 18/657,144

(22) Filed: May 7, 2024

(30) Foreign Application Priority Data
May 30, 2023 (JP) 2023-088481

(51) Int. Cl. H04B 10/079; H04B 10/50; H04J 14/02

(52) U.S. Cl. CPC H04B 10/07955; H04B 10/50; H04J 14/021

(57) ABSTRACT

An optical transmission device includes a transmitter configured to transmit quasi-signal light that belongs to a unit wavelength band that includes at least one vacant wavelength, to another optical transmission device coupled via an optical transmission line, and a specifying circuit configured to specify a zero dispersion wavelength of the optical transmission line, based on information regarding a crosstalk optical power caused by four-wave mixing (FWM) generated at the vacant wavelength of the quasi-signal light, the crosstalk optical power being measured by the another optical transmission device.

### CROSS-REFERENCE TO RELATED APPLICATION

This application is based upon and claims the benefit of priority of the prior Japanese Patent Application No. 2023-88481, filed on May 30, 2023, the entire contents of which are incorporated herein by reference.

### FIELD

The embodiments discussed herein are related to an optical transmission device, an optical transmission system, and an optical transmission method.

### BACKGROUND

A communication technology is known in which a plurality of optical signals with different wavelengths are subjected to wavelength division multiplexing (WDM) for transmission through an optical fiber. Furthermore, a technology is also known in which a zero dispersion wavelength of an optical fiber is measured.

Japanese Laid-open Patent Publication No. 2009-290360, Japanese Laid-open Patent Publication No. 5-180729, and U.S. Pat. No. 5,557,694 are disclosed as related art.

### SUMMARY

According to an aspect of the embodiments, an optical transmission device includes a transmitter configured to transmit quasi-signal light that belongs to a unit wavelength band that includes at least one vacant wavelength, to another optical transmission device coupled via an optical transmission line, and a specifying circuit configured to specify a zero dispersion wavelength of the optical transmission line, based on information regarding a crosstalk optical power caused by four-wave mixing (FWM) generated at the vacant wavelength of the quasi-signal light, the crosstalk optical power being measured by the another optical transmission device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of an optical network;

FIG. 2 is an example of a block diagram of a reconfigurable optical add/drop multiplexer (ROADM);

FIG. 3A is an example of a functional configuration of a central processing unit (CPU) of a ROADM (transmission side);

FIG. 3B is an example of a functional configuration of a CPU of a ROADM (reception side);

FIG. 4 is a flowchart of each of the ROADM (transmission side) and the ROADM (reception side);

FIG. 5 is a diagram for describing an example of stepwise transmission of quasi-signal light and crosstalk light;

FIG. 6 is a graph for describing a relationship between optical power of the quasi-signal light and a crosstalk amount of four-wave mixing;

FIG. 7 is a diagram for describing an example of stepwise transmission of short-wavelength-band (S-band) quasi-signal light and conventional-band (C-band) quasi-signal light;

FIG. 8A is a diagram for describing an example of collective transmission of the quasi-signal light;

FIG. 8B is a diagram for describing an example of collective reception of the quasi-signal light and crosstalk light;

FIG. 9 is another example of the optical network;

FIG. 10 is an example of a block diagram of an in-line amplifier (ILA);

FIG. 11A is a diagram for describing an example of the quasi-signal light transmitted from the ROADM and received by the ILA and the crosstalk light; and

FIG. 11B is a diagram for describing an example of the quasi-signal light transmitted from the ILA and received by the ROADM and the crosstalk light.

### DESCRIPTION OF EMBODIMENTS

There are various types of the optical fiber. For example, an optical fiber such as a single-mode fiber (SMF), a dispersion shifted fiber (DSF), or a non-zero dispersion shifted fiber (NZ-DSF) is used as an optical transmission line.

Incidentally, when a zero dispersion wavelength of the optical transmission line such as the DSF or the NZ-DSF is actually measured, the zero dispersion wavelength may greatly vary within a range of about 15 nanometers (nm). Since a design value of input power of an optical signal to the optical transmission line is fixedly determined by an actual measurement value of the zero dispersion wavelength, when the zero dispersion wavelength varies, it is needed to take measures such as changing magnitude of the input power according to the actual measurement value of the zero dispersion wavelength.

For example, it is also assumed that the zero dispersion wavelength is monitored and the input power is adaptively determined according to a monitoring result. In this case, when an optical time domain reflectometer (OTDR) at three or more wavelengths (for example, four wavelengths or the like) is used, the zero dispersion wavelength may be monitored based on a quadratic or higher-order (for example, cubic or the like) approximate polynomial indicated in JIS C 6827:2015. However, in a case where the OTDR at three or more wavelengths is additionally mounted in an optical transmission device such as a reconfigurable optical add/drop multiplexer (ROADM), a cost burden involved in mounting a light source having three or more wavelengths in the OTDR is generated.

Hereinafter, embodiments of techniques to specify a zero dispersion wavelength of an optical transmission line with existing equipment will be described with reference to the drawings.

### First Embodiment

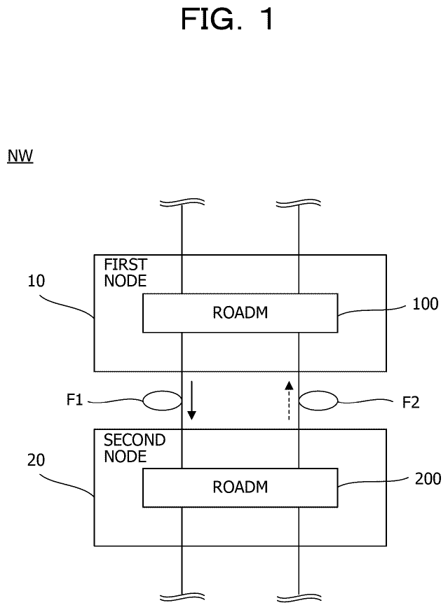

As illustrated in FIG. 1, an optical network NW includes a plurality of reconfigurable optical add/drop multiplexer (ROADM) devices (hereinafter, simply referred to as ROADMs) 100 and 200. The ROADM 100 is an example of an optical transmission device. The ROADM 200 is an example of another optical transmission device. The ROADM 100 is installed in a first node 10. The ROADM 200 is installed in a second node 20. The ROADMs 100 and 200 are coupled to each other by optical transmission lines F1 and F2. The optical transmission lines F1 and F2 may be a dispersion shifted fiber (DSF) or a non-zero dispersion shifted fiber (NZ-DSF).

Although details will be described later, the ROADM 100 transmits, to the ROADM 200, a plurality of beams of amplified spontaneous emission (ASE) light belonging to a predetermined unit wavelength band having a vacant center wavelength as a vacant slot in a stepwise manner as quasi-signal light. As a result, the quasi-signal light is guided from the ROADM 100 positioned upstream of the optical transmission line F1 to the ROADM 200 positioned downstream of the optical transmission line F1.

Furthermore, the ROADM 100 transmits optical supervisory channel (OSC) light to the ROADM 200, and receives OSC light transmitted from the ROADM 200. The OSC light transmitted by the ROADM 100 includes a transmission announcement announcing transmission of the quasi-signal light to the ROADM 200. Furthermore, the OSC light includes a measurement instruction instructing measurement of a crosstalk amount of crosstalk caused by a four-wave mixing (FWM) phenomenon. The crosstalk amount is an example of information regarding a crosstalk optical power due to the FWM (for example, optical power of crosstalk light to be described later). On the other hand, the OSC light received by the ROADM 100 includes the crosstalk amount as a measurement value. The ROADM 100 detects a peak of the crosstalk amount based on the crosstalk amount, and specifies a wavelength corresponding to the detected peak as a zero dispersion wavelength.

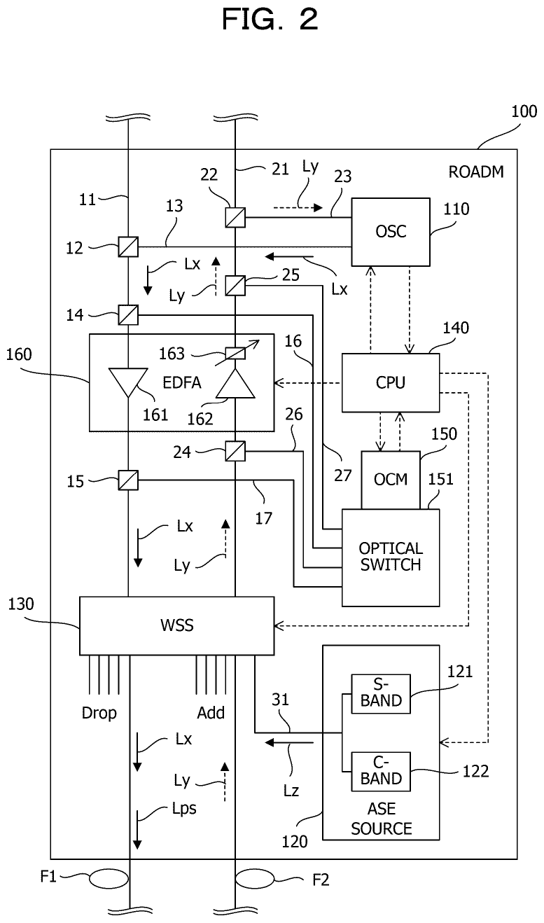

Details of the ROADM 100 will be described with reference to FIG. 2. Note that, since the ROADM 200 has a configuration similar to that of the ROADM 100, detailed description thereof will be omitted.

The ROADM 100 includes an OSC communication unit (hereinafter, simply referred to as OSC) 110, an ASE source 120, and a wavelength selective switch (WSS) 130. Furthermore, the ROADM 100 includes a central processing unit (CPU) 140, an optical channel monitor (OCM) 150, and an erbium doped fiber amplifier (EDFA) 160. An optical switch 151 is coupled to the OCM 150. Note that a transmission unit that transmits quasi-signal light may be implemented by the ASE source 120 and the WSS 130. A control unit that controls an entire operation of the ROADM 100 may be implemented by the CPU 140. An amplification unit may be implemented by the EDFA 160.

The CPU 140 is electrically coupled to the OSC 110, the ASE source 120, the WSS 130, the OCM 150, and the EDFA 160. The CPU 140 controls an operation of each of the OSC 110, the ASE source 120, the WSS 130, the OCM 150, and the EDFA 160 by an electrical control signal. Note that, instead of the CPU 140, a field programmable gate array (FPGA) or an application specific integrated circuit (ASIC) may be adopted as the control unit.

The OSC 110 is optically coupled to an optical splitter 12 via an optical fiber 13. The optical splitter 12 is provided on an optical fiber 11. Furthermore, the OSC 110 is optically coupled to an optical splitter 22 via an optical fiber 23. The optical splitter 22 is provided on an optical fiber 21. The OSC 110 includes, for example, an optical transceiver. The optical transceiver allows the OSC 110 to transmit OSC light. Furthermore, the optical transceiver allows the OSC 110 to receive OSC light transmitted from the ROADM 200.

For example, the OSC 110 transmits OSC light Lx toward the ROADM 200 under the control of the CPU 140. The OSC light Lx includes a transmission announcement of quasi-signal light. The OSC light Lx transfers through the optical fiber 11 toward the ROADM 200. Furthermore, the OSC 110 receives OSC light Ly that is transmitted from the ROADM 200 and transfers through the optical fiber 21. The OSC light Ly includes a crosstalk amount measured by the ROADM 200.

Optical splitters 14 and 15 are provided on the optical fiber 11. The optical splitters 14 and 15 are provided downstream of the optical splitter 12. Optical splitters 24 and 25 are provided on the optical fiber 21. The optical splitters 24 and 25 are provided upstream of the optical splitter 22.

The optical splitters 14, 15, 24, and 25 are all optically coupled to the optical switch 151. For example, the optical splitter 14 is coupled to the optical switch 151 via an optical fiber 16. The optical splitter 15 is coupled to the optical switch 151 via an optical fiber 17. The optical splitter 24 is coupled to the optical switch 151 via an optical fiber 26. The optical splitter 25 is coupled to the optical switch 151 via an optical fiber 27.

The ASE source 120 is optically coupled to the WSS 130. For example, the ASE source 120 is coupled to the WSS 130 via an optical fiber 31. The ASE source 120 includes a first ASE source 121 and a second ASE source 122. The first ASE source 121 emits short-wavelength-band (S-band) ASE light. The second ASE source 122 emits conventional-band (C-band) ASE light. Together with the first ASE source 121 or instead of the first ASE source 121, a third ASE source that emits long-wavelength-band (L-band) ASE light may be provided in the ASE source 120. The ASE source 120 selectively emits either S-band or C-band ASE light Lz under the control of the CPU 140.

The WSS 130 is disposed across both the optical fiber 11 and the optical fiber 21. For example, the WSS 130 is disposed across both between the optical splitter 15 and the optical transmission line F1 and between the optical splitter 24 and the optical transmission line F2. The WSS 130 selects a path for each wavelength according to setting. For example, in a case where the OSC light Lx is input from the optical splitter 15 to the WSS 130, the WSS 130 selects a path for guiding the OSC light Lx to the optical transmission line F1. In a case where the OSC light Ly is input from the optical transmission line F2 to the WSS 130, the WSS 130 selects a path for guiding the OSC light Ly to the optical splitter 24.

Furthermore, when the ASE light Lz is input, the WSS 130 generates quasi-signal light Lps from the ASE light Lz based on control of wavelength setting by the CPU 140. For example, the WSS 130 selects a continuous wavelength of about 20 wavelengths from a plurality of wavelengths belonging to a C-band as a unit wavelength band, and generates, from the ASE light Lz, the quasi-signal light Lps having a vacant center wavelength in the unit wavelength band. When the quasi-signal light Lps is generated, the WSS 130 guides the quasi-signal light Lps to the optical transmission line F1. As a result, the quasi-signal light Lps is guided from the ROADM 100 to the ROADM 200.

Note that, in a case where wavelength division multiplexing (WDM) light obtained by multiplexing a plurality of optical signals having different wavelengths is input to the WSS 130, the WSS 130 guides optical signals having some wavelengths included in the WDM light to a branch unit (drop) according to setting. When an optical signal having a predetermined wavelength is input from an insertion unit (add) to the WSS 130, the WSS 130 multiplexes the optical signal into the WDM light and guides the WDM light to the optical splitter 24.

The EDFA 160 is disposed across both the optical fiber 11 and the optical fiber 21. For example, the EDFA 160 is disposed across both between the optical splitters 14 and 15 and between the optical splitters 24 and 25. The EDFA 160 includes a first amplification unit 161, a second amplification unit 162, and an attenuation unit 163. The attenuation unit 163 is coupled to an output end of the second amplification unit 162. The attenuation unit 163 may be implemented by, for example, a variable optical attenuator (VOA). The first amplification unit 161 is disposed between the optical splitters 14 and 15. The second amplification unit 162 and the attenuation unit 163 are disposed between the optical splitters 24 and 25. The first amplification unit 161 amplifies the OSC light Lx based on control of power setting by the CPU 140. The second amplification unit 162 amplifies the OSC light Ly based on control of power setting by the CPU 140. The attenuation unit 163 adjusts optical power of the OSC light Ly amplified by the second amplification unit 162 to desired transmission line input power under the control of the CPU 140. Note that, in a case where WDM light transfers through the optical fiber 11 or the optical fiber 21, the first amplification unit 161 or the second amplification unit 162 amplifies the WDM light based on control of power setting by the CPU 140. Furthermore, in the case where the WDM light transfers through the optical fiber 11 or the optical fiber 21, the attenuation unit 163 adjusts optical power of the WDM light amplified by the second amplification unit 162 to desired transmission line input power under the control of the CPU 140.

The optical switch 151 switches an optical path in units of wavelengths under the control of the CPU 140. As a result, the OCM 150 monitors and measures optical power of each wavelength of quasi-signal light, and electrically notifies the CPU 140 of a measurement result. Note that, although details will be described later, in the present embodiment, the OCM provided in the ROADM 200 monitors and measures the optical power of each wavelength of the quasi-signal light Lps.

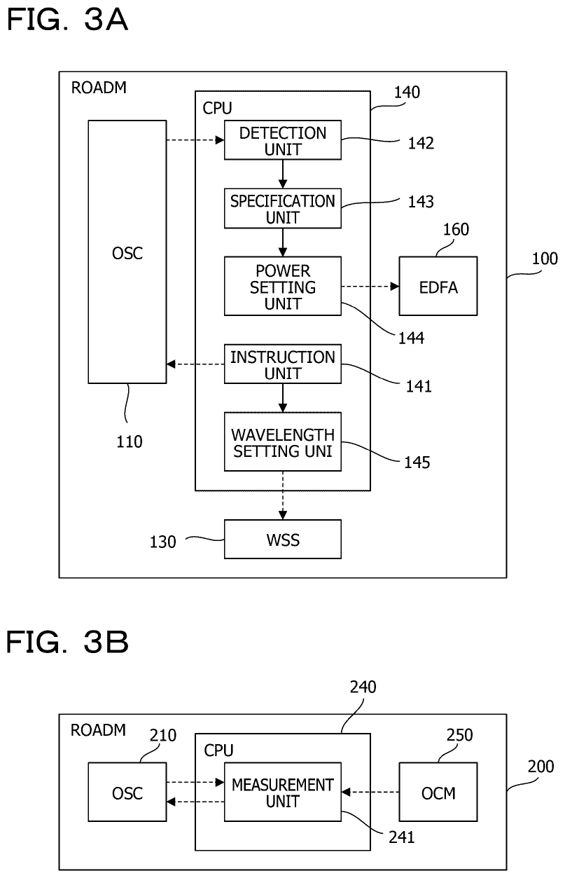

Details of the CPU 140 of the ROADM 100 and a CPU 240 of the ROADM 200 will be described with reference to FIGS. 3A and 3B. Note that the CPU 140 and the CPU 240 have basically similar configurations, but in the present embodiment, the configurations will be described separately by dividing into roles of the CPU 140 and the CPU 240. As illustrated in FIG. 3A, the CPU 140 includes an instruction unit 141, a detection unit 142, a specification unit 143, a power setting unit 144, and a wavelength setting unit 145. As illustrated in FIG. 3B, the CPU 240 includes a measurement unit 241.

As illustrated in FIG. 3A, based on an instruction from a management device (not illustrated) that manages the optical network NW, the instruction unit 141 instructs the OSC 110 to issue a measurement instruction instructing the ROADM 200 to measure a crosstalk amount and to perform notification of a transmission announcement announcing transmission of the quasi-signal light Lps. As a result, the OSC 110 transmits the OSC light Lx including the measurement instruction and the transmission announcement to the ROADM 200.

The wavelength setting unit 145 instructs, when completion of an output is notified from the instruction unit 141, the WSS 130 to generate and transmit the quasi-signal light Lps. When the C-band ASE light Lz is emitted to the WSS 130, the WSS 130 generates the quasi-signal light Lps from the ASE light Lz, and transmits the quasi-signal light Lps to the ROADM 200. In this manner, the WSS 130 transmits the quasi-signal light Lps in cooperation with the ASE source 120.

As illustrated in FIG. 3B, when an OSC 210 of the ROADM 200 receives the OSC light Lx, the measurement unit 241 stands by for reception of the quasi-signal light Lps by an OCM 250 based on the transmission announcement included in the OSC light Lx. When the OCM 250 monitors the quasi-signal light Lps and receives the quasi-signal light Lps transmitted from the ROADM 100, the measurement unit 241 measures a crosstalk amount based on the quasi-signal light Lps. After measuring the crosstalk amount, the measurement unit 241 notifies the OSC 210 of the crosstalk amount. As a result, the OSC 210 transmits the OSC light Ly including the crosstalk amount to the ROADM 100.

The detection unit 142 detects, when the OSC 110 receives the OSC light Ly, a peak of the crosstalk amount included in the OSC light Ly. The specification unit 143 specifies, when the peak of the crosstalk amount is detected by the detection unit 142, a wavelength corresponding to the detected peak of the crosstalk amount as a zero dispersion wavelength. The power setting unit 144 sets an amplification degree of the EDFA 160 based on the zero dispersion wavelength specified by the specification unit 143. As a result, the ROADM 100 may adaptively determine input power to the optical transmission line F1 based on the zero dispersion wavelength.

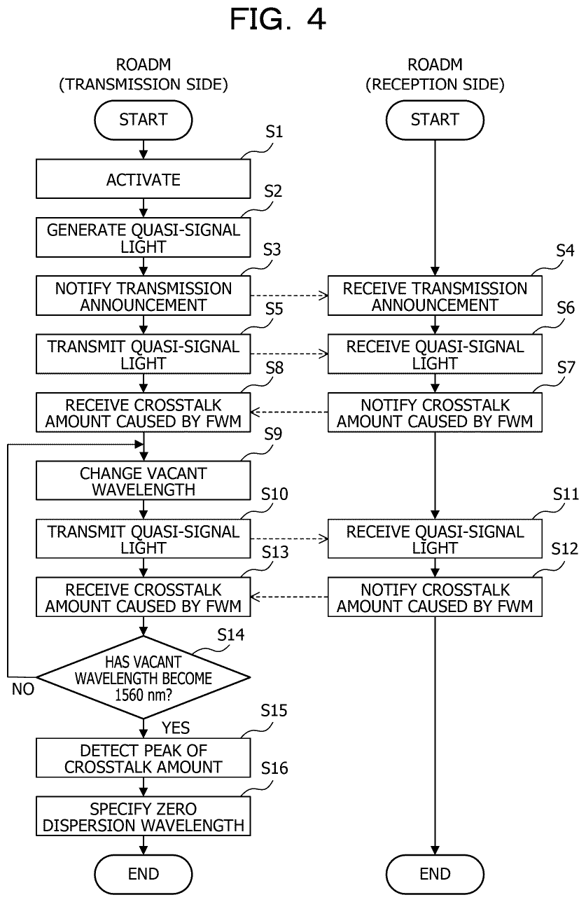

Operations of the ROADMs 100 and 200 will be described with reference to FIGS. 4 to 6.

First, as illustrated in FIG. 4, the CPU 140 activates the OSC 110, the ASE source 120, the WSS 130, the OCM 150, and the EDFA 160 (operation S1). For example, when detecting an instruction from the management device described above, the CPU 140 activates the OSC 110, the ASE source 120, the WSS 130, the OCM 150, and the EDFA 160. Furthermore, the CPU 140 activates the OSC 210 and the OCM 250 in cooperation with the CPU 240.

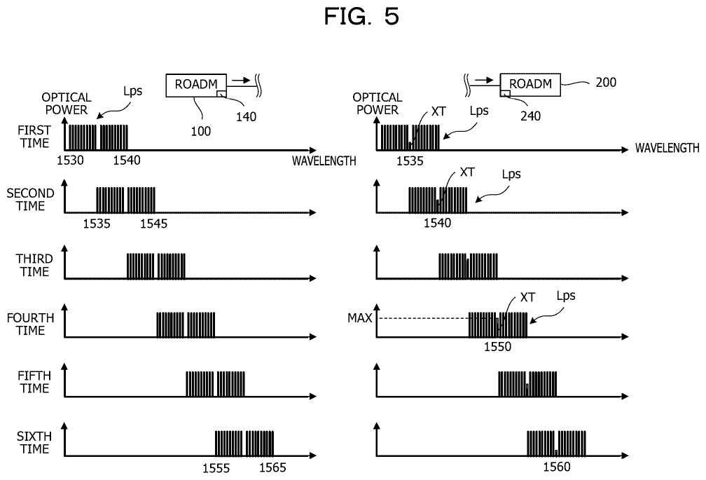

When the processing of operation S1 is completed, the CPU 140 generates quasi-signal light (operation S2). For example, when the wavelength setting unit 145 controls the WSS 130, the WSS 130 generates, from the ASE light Lz, the quasi-signal light Lps in a unit wavelength band including a plurality of wavelengths in increments of 0.5 nm from 1530 nm to 1540 nm having a vacant center wavelength of 1535 nm as illustrated in a first time on a left side of FIG. 5.

When the processing of operation S2 is completed, the CPU 140 notifies a transmission announcement of the quasi-signal light Lps (operation S3), and the CPU 240 receives the transmission announcement (operation S4). For example, the instruction unit 141 of the CPU 140 notifies the measurement unit 241 of the CPU 240 of a transmission announcement and a measurement instruction via the OSCs 110 and 210, and the measurement unit 241 receives the transmission announcement and the measurement instruction.

When the processing of operation S4 is completed, the CPU 140 transmits the quasi-signal light Lps (operation S5), and the CPU 240 receives the quasi-signal light Lps (operation S6). For example, the wavelength setting unit 145 of the CPU 140 requests the WSS 130 to transmit the quasi-signal light Lps. As a result, the WSS 130 transmits the quasi-signal light Lps to the ROADM 200. Then, the OCM 250 (see FIG. 3B) of the ROADM 200 monitors the quasi-signal light Lps, so that the CPU 240 receives the quasi-signal light Lps. As a result, as illustrated in the first time on a right side of FIG. 5, idler light (hereinafter, referred to as crosstalk light) XT caused by an FWM phenomenon appears at the center wavelength of 1535 nm of the quasi-signal light Lps.

Note that the reason why the crosstalk light XT appears is as follows. When beams of light having three equally spaced wavelengths are input to an optical fiber with high power, a fourth beam of light having a wavelength corresponding to a sum or difference of the three wavelengths is generated. The phenomenon in which the fourth beam of light is generated is referred to as four-wave mixing. For example, a phenomenon in which two beams of light other than beams of light at both ends among the four beams of light overlap each other is referred to as degenerated four-wave mixing. As a result, the number of beams of light becomes three. For example, a beam of light obtained by degeneration and overlapping appears at a center of the two beams of light other than the beams of light at both ends. The crosstalk light XT according to the present embodiment corresponds to a center of the center wavelength and three beams of light adjacent thereto. For the four-wave mixing, reference may also be made to the following document.
Documents: Osamu Aso and two others, “Four-Wave Mixing in Optical Fibers and Development of Its Applications”, WDM-related technologies small special issue, Furukawa Electric Review, January 2000, No. 105, pp. 46-51

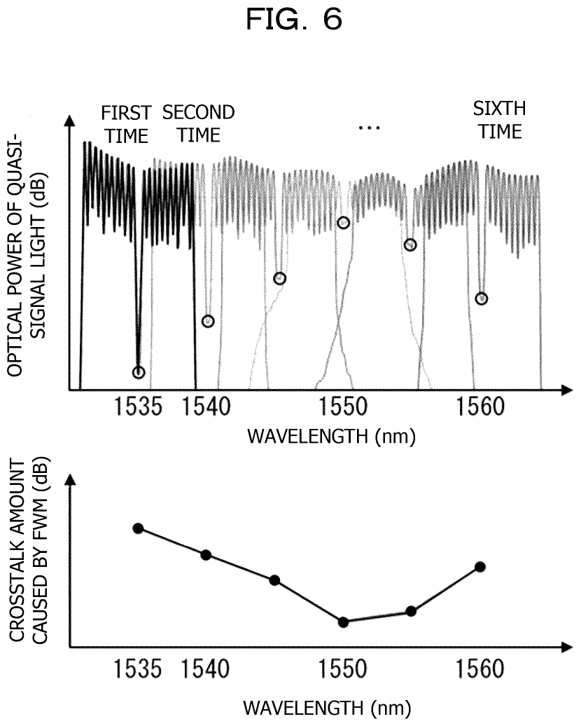

When the processing of operation S6 ends, the CPU 240 notifies a crosstalk amount caused by the FWM phenomenon (operation S7), and the CPU 140 receives the crosstalk amount caused by the FWM phenomenon (operation S8). For example, the measurement unit 241 of the CPU 240 measures the crosstalk amount caused by the FWM phenomenon based on a minimum value of optical power of the quasi-signal light Lps monitored and measured by the OCM 250. For example, as illustrated in an upper part of FIG. 6, when the OCM 250 measures the minimum value of the optical power of the quasi-signal light Lps of the first time, the crosstalk amount is measured as illustrated in a lower part of FIG. 6. After measuring the crosstalk amount, the measurement unit 241 notifies the CPU 140 of the crosstalk amount via the OSCs 210 and 110. As a result, the CPU 140 receives the crosstalk amount caused by the FWM phenomenon.

When the processing of operation S8 is completed, the CPU 140 changes the vacant wavelength (operation S9). For example, the CPU 140 moves the vacant wavelength to a long wavelength side by 5 nm. Since the vacant wavelength at the time of transmission of the quasi-signal light Lps of the first time is 1535 nm, the CPU 140 changes the vacant wavelength at the time of transmission of the quasi-signal light Lps of a second time to 1540 nm by the processing of operation S9.

When the processing of operation S9 is completed, similarly to the processing of operations S5 and S6, the CPU 140 transmits the quasi-signal light Lps (operation S10), and the CPU 240 receives the quasi-signal light Lps (operation S11). As a result, as illustrated in the second time on the right side of FIG. 5, the crosstalk light XT caused by the FWM phenomenon appears at the center wavelength of 1540 nm of the quasi-signal light Lps.

When the processing of operation S11 ends, similarly to the processing of operations S7 and S8, the CPU 240 notifies a crosstalk amount caused by the FWM phenomenon (operation S12), and the CPU 140 receives the crosstalk amount caused by the FWM phenomenon (operation S13). As a result, the CPU 140 newly receives the crosstalk amount different from that of the first time.

When the processing of operation S13 is completed, the CPU 140 determines whether or not the vacant wavelength has become 1560 nm (operation S14). For example, the wavelength setting unit 145 of the CPU 140 determines whether or not the vacant wavelength has become 1560 nm. In a case where the vacant wavelength has not become 1560 nm (operation S14: NO), the processing returns to operation S9, and the CPU 140 repeats the processing from operations S9 to S13. As a result, as illustrated in FIG. 5, for third to sixth times, the quasi-signal light Lps is transmitted from the CPU 140, and the CPU 240 receives the quasi-signal light Lps.

At this time, optical power of the crosstalk light XT appearing at the center wavelength of the quasi-signal light Lps received by the CPU 240 changes according to the quasi-signal light Lps transmitted by the CPU 140. For example, in the present embodiment, in a case where the quasi-signal light Lps of the fourth time is transmitted, the optical power of the crosstalk light XT is maximized as compared with cases of other times such as the second time and the sixth time. Since such a crosstalk amount corresponding to the optical power of the crosstalk light XT is notified from the CPU 240 to the CPU 140, the CPU 140 receives a plurality of various crosstalk amounts regarding the crosstalk light XT.

Then, in a case where the vacant wavelength has become 1560 nm (operation S14: YES), the CPU 140 detects a peak of the crosstalk amount caused by the FWM phenomenon (operation S15). For example, the detection unit 142 of the CPU 140 detects the peak of the crosstalk amount from among the plurality of crosstalk amounts. In the present embodiment, the detection unit 142 detects, as the peak of the crosstalk amount, the crosstalk amount corresponding to the optical power of the crosstalk light XT that has appeared when the quasi-signal light Lps of the fourth time is transmitted.

When the processing of operation S15 is completed, the CPU 140 specifies a zero dispersion wavelength (operation S16), and ends the processing. For example, the specification unit 143 of the CPU 140 specifies the zero dispersion wavelength. In the present embodiment, as the zero dispersion wavelength, the specification unit 143 specifies 1550 nm, which is a wavelength corresponding to the peak of the crosstalk amount detected by the detection unit 142. Then, when the specification unit 143 specifies the zero dispersion wavelength, the power setting unit 144 sets an amplification degree suitable for the zero dispersion wavelength specified by the specification unit 143 in the EDFA 160. As a result, input power to the optical transmission line F1 is appropriately set.

As a result, for example, in a case where the input power is set assuming that a worst value of the zero dispersion wavelength is 1565 nm, when an actual measurement value of the zero dispersion wavelength is 1550 nm, there is a possibility that optimum input power decreases by about 2 dB, but such a possibility may be avoided by the present embodiment. For example, since the input power may be set based on the actual measurement value of the zero dispersion wavelength, it is unnecessary to design the input power assuming the worst value of the zero dispersion wavelength. Therefore, it is possible to provide an optical communication service having the best characteristics adapted to the existing optical transmission line F1. For example, it is not needed to additionally mount an OTDR in the ROADM 100, and it is possible to use the ASE source 120 which is existing equipment. Therefore, it is possible to avoid generation of a cost burden involved in the mounting of the OTDR.

### Second Embodiment

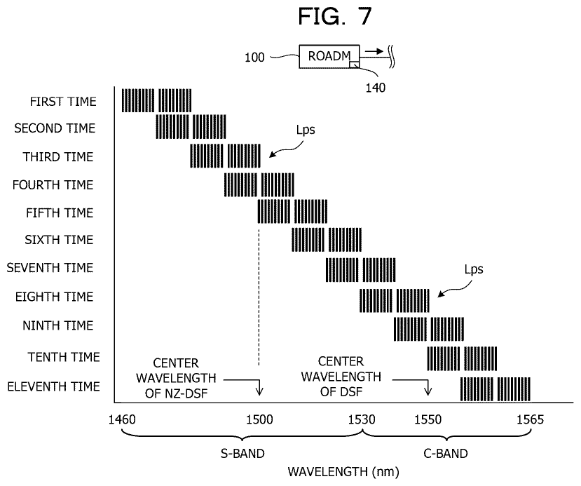

Subsequently, a second embodiment of the present embodiments will be described with reference to FIG. 7. In the first embodiment, C-band quasi-signal light Lps has been described as an example, but as illustrated in FIG. 7, S-band quasi-signal light Lps may be used together with the C-band quasi-signal light Lps. As a result, by slightly shifting a zero dispersion wavelength from a 1550 nm band to a short wavelength side, it is similarly unnecessary to assume a worst value for a NZ-DSF in which a nonlinear phenomenon in the 1550 nm band is suppressed.

Similarly to the first embodiment, a CPU 140 of a ROADM 100 transmits S-band quasi-signal light Lps in a stepwise manner from a first time to a fifth time. The CPU 140 may specify a zero dispersion wavelength of a NZ-DSF, which is an example of an optical transmission line F1, based on a crosstalk amount received from a CPU 240 of a ROADM 200.

Thereafter, the CPU 140 transmits C-band quasi-signal light Lps in a stepwise manner from a sixth time to an eleventh time. The CPU 140 may specify a zero dispersion wavelength of a DSF, which is an example of the optical transmission line F1, based on the crosstalk amount received from the CPU 240 of the ROADM 200.

### Third Embodiment

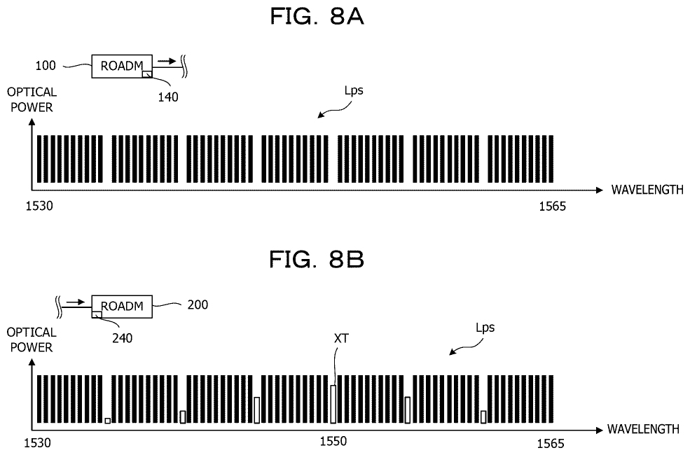

Subsequently, a third embodiment of the present embodiments will be described with reference to FIGS. 8A and 8B. In the embodiment described above, it has been described that the CPU 140 of the ROADM 100 transmits the quasi-signal light Lps in the unit wavelength band in units of 20 wavelengths in a stepwise manner. In the third embodiment, as illustrated in FIG. 8A, a CPU 140 may collectively transmit quasi-signal light Lps having all wavelengths belonging to a C-band having vacant wavelengths at 5 nm spaces. As a result, as illustrated in FIG. 8B, it is sufficient that a CPU 240 of a ROADM 200 measures a peak of a crosstalk amount corresponding to optical power of crosstalk light XT once.

As a result, the CPU 140 may specify a zero dispersion wavelength corresponding to the peak of the crosstalk amount measured by the CPU 240. According to the third embodiment, the number of times of measurement by the CPU 240 is reduced. As a result, the zero dispersion wavelength is specified in a short time by the CPU 140. On the other hand, in a case where the quasi-signal light Lps is transmitted in a stepwise manner, unlike a case where the quasi-signal light Lps is collectively transmitted, measurement is performed a plurality of times, but the optical power of the crosstalk light XT is accurately detected in each time. As a result, there is an advantage different from that of the third embodiment that the crosstalk amount corresponding to the optical power of the crosstalk light XT may be accurately measured.

### Fourth Embodiment

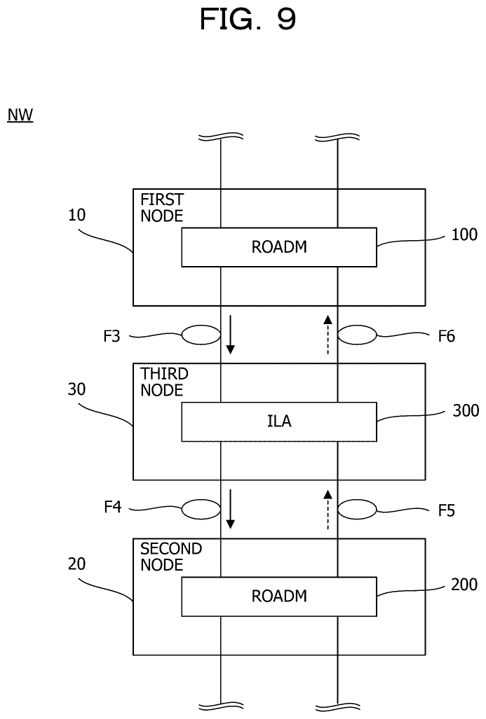

Subsequently, a fourth embodiment of the present embodiments will be described with reference to FIGS. 9 to 11B. In the embodiment described above, it has been described that the ROADMs 100 and 200 are coupled via the optical transmission lines F1 and F2. In the fourth embodiment, as illustrated in FIG. 9, an in-line amplifier (ILA) 300 may be provided between ROADMs 100 and 200. The ILA 300 is an example of an optical transmission device, and is installed in, for example, a third node 30. The ROADM 100 and the ILA 300 are coupled to each other by optical transmission lines F3 and F6. The optical transmission line F3 is an example of an upstream optical transmission line, and the optical transmission line F6 is an example of a downstream optical transmission line. The ROADM 200 and the ILA 300 are coupled to each other by optical transmission lines F4 and F5.

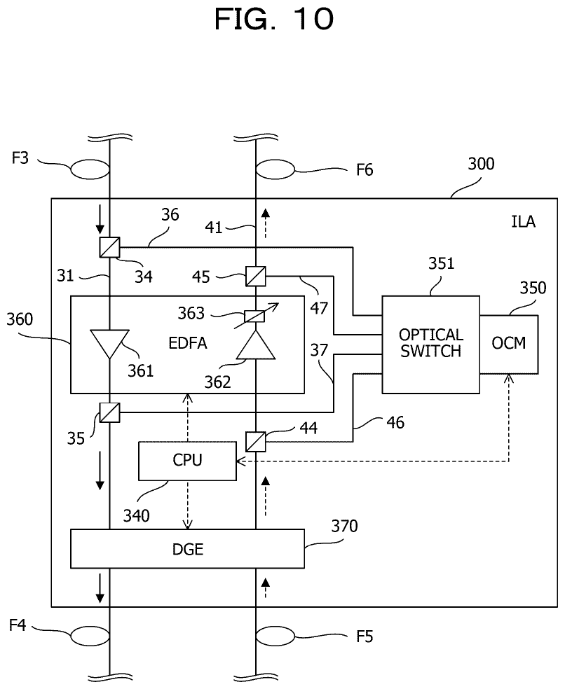

As illustrated in FIG. 10, the ILA 300 includes a CPU 340, an OCM 350, an EDFA 360, and a dynamic gain equalizer (DGE) 370. The DGE 370 is an example of a transferring unit and a blocking unit. An optical switch 351 is coupled to the OCM 350. Note that, in FIG. 10, configurations similar to those of the ROADM 100 are denoted by corresponding reference signs, and detailed description thereof will be omitted. For example, an optical fiber 36 corresponds to the optical fiber 16, and an optical fiber 46 corresponds to the optical fiber 26. Furthermore, a first amplification unit 361 corresponds to the first amplification unit 161, a second amplification unit 362 corresponds to the second amplification unit 162, and an attenuation unit 363 corresponds to the attenuation unit 163.

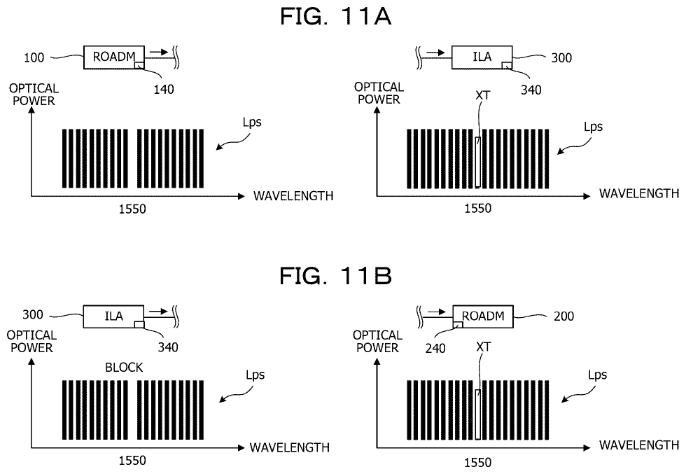

The DGE 370 dynamically controls optical power for each wavelength under the control of the CPU 340. For example, as illustrated in FIG. 11A, in a case where a CPU 140 of the ROADM 100 transmits quasi-signal light Lps having a vacant center wavelength of 1550 nm, the CPU 340 of the ILA 300 receives the quasi-signal light Lps. When the quasi-signal light Lps transfers through the optical transmission line F3, crosstalk light XT caused by an FWM phenomenon is generated.

The CPU 340 measures optical power of the quasi-signal light Lps monitored by the OCM 350 via the optical switch 351. When confirming appearance of the crosstalk light XT, the CPU 340 notifies the DGE 370 of 1550 nm which is a wavelength at which the crosstalk light XT is generated. As a result, as illustrated in FIG. 11B, the DGE 370 blocks the crosstalk light XT having the corresponding wavelength, and generates the quasi-signal light Lps again. For example, the DGE 370 consequently allows the quasi-signal light Lps to transfer.

In a case where the CPU 340 transmits the quasi-signal light Lps obtained by blocking the center wavelength of 1550 nm, a CPU 240 of the ROADM 200 receives the quasi-signal light Lps. When the quasi-signal light Lps transfers through the optical transmission line F4, the crosstalk light XT caused by the FWM phenomenon is generated. The CPU 240 measures the optical power of the quasi-signal light Lps monitored by an OCM 250 via an optical switch 251. The CPU 240 notifies the CPU 140 of a crosstalk amount corresponding to the optical power of the crosstalk light XT via OSCs 210 and 110. As a result, the CPU 140 receives the crosstalk amount caused by the FWM phenomenon. As a result, the CPU 140 may specify a zero dispersion wavelength based on the crosstalk amount. In this manner, according to the fourth embodiment, even when the ILA 300 is interposed between the ROADMs 100 and 200, the ROADM 100 may specify the zero dispersion wavelength with existing equipment.

Although the preferred embodiments have been described in detail thus far, the embodiments are not limited to specific embodiments, and various modifications and alterations may be made within the scope of the present embodiments described in the claims. For example, in the embodiment described above, the optical splitter has been described as an example, but an optical tap or a wavelength filter may be adopted instead of the optical splitter.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmission device comprising:
a transmitter configured to transmit quasi-signal light that belongs to a unit wavelength band that includes at least one vacant wavelength, to another optical transmission device coupled via an optical transmission line; and
a specifying circuit configured to specify a zero dispersion wavelength of the optical transmission line, based on information regarding a crosstalk optical power caused by four-wave mixing (FWM) generated at the vacant wavelength of the quasi-signal light, the crosstalk optical power being measured by the another optical transmission device.

2. The optical transmission device according claim 1,
wherein the transmitter is configured to transmit, into a plurality of different unit wavelength bands, the quasi-signal light that belongs to a predetermined unit wavelength band that includes a vacant center wavelength, to the another optical transmission device, and
wherein the specifying circuit is configured to specify the zero dispersion wavelength, based on the information regarding the crosstalk optical power caused by the FWM generated at the center wavelength of the quasi-signal light in the plurality of different unit wavelength bands.

3. The optical transmission device according to claim 1,
wherein the transmitter is configured to transmit the quasi-signal light that belongs to a predetermined wavelength band that includes a plurality of different wavelengths vacant at unit wavelength spaces, to the another optical transmission device, and
wherein the specifying circuit is configured to specify the zero dispersion wavelength, based on the information regarding the crosstalk optical power caused by the FWM generated at the plurality of different wavelengths vacant at unit wavelength spaces in the predetermined wavelength band.

4. The optical transmission device according to claim 1, wherein the specifying circuit specifies the zero dispersion wavelength based on a peak value of the crosstalk optical power caused by the FWM.

5. The optical transmission device according to claim 1, wherein the quasi-signal light is generated by an amplified spontaneous emission (ASE) source.

6. The optical transmission device according to claim 1, further comprising:
an amplifier configured to amplify signal light inputted to the optical transmission device to transmit the amplified signal light to the optical transmission line; and
a processor configured to set, for the amplifier, input power to the optical transmission line, based on the zero dispersion wavelength.

7. The optical transmission device according to claim 1, wherein the optical transmission line includes a dispersion shifted fiber (DSF).

8. The optical transmission device according to claim 1, wherein the wavelength band includes a conventional-band (C-band).

9. The optical transmission device according to claim 1, wherein the wavelength band includes a short-wavelength-band (S-band).

10. An optical transmission system comprising:
a first optical transmission device configured to include:
a transmitter configured to transmit quasi-signal light that belongs to a unit wavelength band that includes at least one vacant wavelength, to another optical transmission device coupled via an optical transmission line, and
a specifying circuit configured to specify a zero dispersion wavelength of the optical transmission line, based on information regarding a crosstalk optical power caused by four-wave mixing (FWM) generated at the vacant wavelength of the quasi-signal light, the crosstalk optical power being measured by the another optical transmission device; and
a second optical transmission device, as the another optical transmission device, configured to include:
a transferring circuit configured to transfer the quasi-signal light that belongs to the unit wavelength band that includes the at least one vacant wavelength transmitted from the first optical transmission device via an upstream optical transmission line to a downstream optical transmission line, and
a blocking circuit configured to block crosstalk light caused by the FWM generated at the vacant wavelength in the upstream optical transmission line.

11. An optical transmission method of an optical transmission device, the optical transmission method comprising:
transmitting quasi-signal light that belongs to a unit wavelength band that includes at least one vacant wavelength, to another optical transmission device coupled via an optical transmission line; and
specifying a zero dispersion wavelength of the optical transmission line, based on information regarding a crosstalk optical power caused by four-wave mixing (FWM) generated at the vacant wavelength of the quasi-signal light, the crosstalk optical power being measured by the another optical transmission device.
